(19) United States
(12) Patent Application Publication
(10) Pub. No.: US 2008/0300994 A1
(43) Pub. Date: Dec. 4, 2008

(54) System and method for conveying information

(75) Inventors: Kevin R. Kulak, Naperville, IL (US); Phillip S. Dinh, Plainfield, IL (US); John J. Kellen, Yorkville, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/806,434

(22) Filed: May 31, 2007

(51) Int. Cl. G06Q 20/00

(52) U.S. Cl. 705/23

(57) ABSTRACT

A computer system is provided that may include a platform, a display device, and a processor in communication with the platform and the display device. The processor may be configured to receive a bill of materials listing elements, receive models of the elements, and receive information on the quality of the elements. The processor may also be configured to identify matches between the information and the elements by comparing the information to each of the elements. The processor may further be configured to generate visual indicators on the models based on the matches, and display the models and the visual indicators on the display device.

### TECHNICAL FIELD

The present disclosure relates generally to a system and method for conveying information and relates more particularly to a system and method for conveying information using visual representations and visual indicators.

### BACKGROUND

Information associated with products may be of interest to sellers, buyers, manufacturers, and other business entities. The information may identify characteristics of the product, including, for example, the product's cost, source, composition, and other characteristics of or associated with the product, such as warranty information. An product may be sold or otherwise transferred from a dealer to a customer with a warranty. The warranty may cover one or more components of the product, and when a customer experiences a problem with a component covered by the warranty, the customer may make a warranty claim to have the problem fixed. In making the warranty claim, the customer may provide the dealer with information, including, for example, a description of the problem, the affected part or parts, the environment in which the problem occurred, and other suitable data. Such information may be of particular importance to the dealer because the dealer may find it useful for diagnosing malfunctions, anticipating future problems, and designing improved products.

At least one system has been developed to convey warranty information to a viewer. For example, U.S. Patent Application Publication No. 2003/0149590 to Cardno et al. discloses a retrieval device configured to retrieve data representing interactions between customers and merchants, and to construct a finite set of data values from the retrieved data. Cardno also discloses a display arranged to display a graphical representation of at least one item, such as a chair, and to superimpose one or more contoured representations of the data values on the graphical representation of the item. However, Cardno does not provide a user with the ability to identify specific components within a complex assembly. Cardno also does not provide a tool for distinguishing a component from a plurality of identical components based on the context in which the component is used.

The system and method of the present disclosure is directed towards overcoming one or more of the constraints set forth above.

### SUMMARY OF THE INVENTION

In one aspect, the presently disclosed embodiments may be directed to a computer system including a platform, a display device, and a processor in communication with the platform and the display device. The processor may be configured to receive a bill of materials listing elements, receive models of the elements, and receive information on characteristics of the elements. The processor may also be configured to identify matches between the information and the elements by comparing the information to each of the elements. The processor may further be configured to generate visual indicators on the models based on the matches, and display the models and the visual indicators on the display device.

In another aspect, the presently disclosed embodiments may be directed to a computer readable medium that may include instructions for receiving a bill of materials listing elements, receiving models of the elements, and receiving information on characteristics of the elements. The computer readable medium may also include instructions for identifying matches between the information and the elements by comparing the information to each of the elements. The computer readable medium may also include instructions for generating visual indicators on the models based on the matches, and displaying the models and the visual indicators on a display device.

In yet another aspect, the presently disclosed embodiments may be directed to a method for conveying warranty information. The method may include receiving a bill of materials listing elements, receiving models of the elements, and receiving information on characteristics of the elements. The method may also include identifying matches between the information and the elements by comparing the information to each of the elements. The method may further include generating visual indicators on the models based on the matches, and displaying the models and the visual indicators on a display device.

### BRIEF DESCRIPTION OF THE DRAWINGS

FIG. 1 is a schematic illustration of a system for conveying warranty information, according to an exemplary embodiment of the present disclosure.

FIG. 2 is a flow diagram of a method for conveying warranty information, according to an exemplary embodiment of the present disclosure.

FIG. 3 is an illustration of a display window, according to an exemplary feature of the present disclosure.

FIG. 4 is an illustration of a model, according to another exemplary feature of the present disclosure.

FIG. 5 is an illustration of a data set, according to an exemplary feature of the present disclosure.

### DETAILED DESCRIPTION

A system 10 for conveying information may be used in virtually any business environment involved in the manufacture, transport, storage, and/or sale of products. Products may include, for example, machines, including earth-moving machines, on and off-highway vehicles, engines, generators, and other types of equipment. The products may be composed of components and assemblies of components. System 10 may receive, process, and convey information to help with improvement of products, assemblies, and components. In exemplary embodiments of this disclosure, the information may include cost information, source-identifying information, composition information, replacement parts information, and/or logistics planning information, related to products, assemblies, and components.

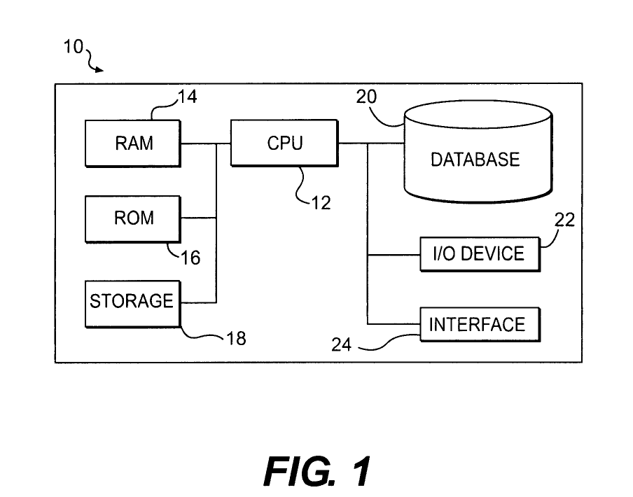

System 10 may include any type of processor-based system on which processes and methods consistent with the disclosed embodiments may be implemented. For example, as illustrated in FIG. 1, system 10 may be a platform that includes one or more hardware and/or software components configured to execute software programs. System 10 may include one or more hardware components such as a central processing unit (CPU) 12, a random access memory (RAM) module 14, a read-only memory (ROM) module 16, a storage 18, a database 20, an input/output (I/O) device 22, and an interface 24. System 10 may also include one or more software components, such as a computer-readable medium including computer-executable instructions, for performing methods consistent with certain disclosed embodiments. One or more of the hardware components listed above may implement the software, and in doing so, may perform one or more operations. System 10 may include additional, fewer, and/or different components than those listed above, as the components listed above are exemplary and not intended to be limiting.

CPU 12 may include one or more processors, each configured to execute instructions and process data to perform one or more functions associated with system 10. CPU 12 may be communicatively coupled to RAM 14, ROM 16, storage 18, database 20, I/O device 22, and interface 24. CPU 12 may execute sequences of computer program instructions to perform various processes, which will be described in detail below. The computer program instructions may be loaded into RAM for execution by CPU 12.

RAM 14 and ROM 16 may each include one or more devices for storing information associated with operations of system 10 and CPU 12. RAM 14 may include a memory device for storing data associated with one or more operations of CPU 12. ROM 16 may include a memory device configured to access and store information associated with system 10, including information for creating and monitoring one or more tasks. ROM 16 may load instructions into RAM 14 for execution by CPU 12.

Storage 18 may include any type of mass storage device configured to store information that CPU 12 may need to perform processes consistent with the disclosed embodiments. For example, storage 18 may include one or more magnetic and/or optical disk devices, such as hard drives, CD-ROMs, DVD-ROMs, or any other type of mass media device.

Database 20 may include one or more software and/or hardware components that cooperate to store, organize, sort, filter, and/or arrange data used by system 10 and CPU 12. Database 20 may store a bill of materials (BOM), which may include a list of elements, such as an product, assemblies that compose the product, and components that compose the assemblies. The elements may be arranged in a hierarchy. A hierarchy may include a system of ranking and organizing elements. A top of the hierarchy may correspond to a high level element, for example, one that is composed of subordinate elements. Branches may extend from the top element to primary subordinate elements corresponding to parts of the high level element. Each of the primary subordinate elements may be connected by branches to secondary subordinate elements, which may correspond to parts of the primary subordinate elements. This top down arrangement of elements may continue until a bottom level of elements are reached that correspond to single components. The bottom of the hierarchy may be the bottom level.

Database 20 may also store visual representations of each of the items listed in the BOM. The visual representations may include 3-D models of products, assemblies, and their components. The visual representations may be created using computer-aided design, or any other suitable computer modeling applications. The visual representations may depict products, assemblies, and components, from one or more points of view. The assemblies and components may be portrayed in semi-transparent form, to ensure that each of the assemblies and components may be visible, at least in part, even if they are behind one or more of the other assemblies and components. The visual representations may be rotated for viewing at alternate angles, enlarged, reduced, shown in exploded view, or presented in any other suitable fashion, as would be apparent to one skilled in the art.

Database 20 may also store various types of information, including, for example, warranty claim information. The warranty claim information may describe the type of and/or quantity of warranty claims made by customers on products, assemblies, and components. The warranty information may include identifiers that identify the products, assemblies, and components to which the warranty claim information applies. Cost information may also be stored in database 20. Cost information may include manufacturing costs, shipping costs, inventory costs, purchase costs, overcosts, and/or any other suitable costs associated with products, assemblies, and components. It is also contemplated that source-identifying information may also be stored on database 20. Source-identifying information may describe the source of products, assemblies, and components. A source may include a third party that sells goods or services, and/or an internal department of a business that provides goods or services to other departments. Source-identifying information may also describe where and/or when products, assemblies, and components were, are, or will be received. Additionally, composition information may also be stored in database 20. Composition information may describe, for example, the physical make up or chemical composition of products, assemblies, and components, methods used to produce them, and/or the proportion or combination of elements in objects. Replacement parts information may also be stored in database 20. Replacement parts information may describe, for example, number of units sold for a replacement part, or the frequency of use of a replacement part. Further, logistics planning information may also be stored in database 20. Logistics planning information may describe where, when, and/or how, products, assemblies, and components were, are, or should be received, placed, stored, picked, and sent out. The types of information described herein are exemplary, and it should be understood that the information may include any suitable information of interest to a business. CPU 12 may access the information stored in database 20, and may process, organize, and convey the information to users.

I/O device 22 may include one or more components configured to communicate information between a user and system 10. For example, I/O device 22 may include a console with an integrated keyboard and mouse to allow a user to input parameters associated with system 10. I/O device 22 may also include a display, such as a monitor, including a graphical user interface (GUI) for outputting information. I/O device 22 may also include peripheral devices such as, for example, a printer for printing information and reports associated with system 10, a user-accessible disk drive (e.g., a USB port, a floppy, CD-ROM, or DVD-ROM drive) to allow a user to input data stored on a portable media device, a microphone, a speaker system, or any other suitable type of interface device. Output from system 10 may be sent to I/O device 22 for printed display, viewing, and/or further communication to other system devices.

Interface 24 may include one or more components configured to transmit and receive data via a communication network, such as the Internet, a local area network, a workstation peer-to-peer network, a direct link network, a wireless network, or any other suitable communication platform. In this manner, system 10 may communicate with external systems through the use of a network architecture (not shown). In such an embodiment, the network architecture may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components and systems. For example, interface 24 may include one or more modulators, demodulators, multiplexers, demultiplexers, network communication devices, wireless devices, antennas, modems, and any other type of device configured to enable data communication via a communication network.

Those skilled in the art will appreciate that all or part of systems and methods consistent with the present disclosure may be stored on or read from other computer-readable media. System 10 may execute instructions provided in a computer-readable medium having stored thereon machine executable instructions for performing, among other things, the methods disclosed herein. Exemplary computer readable media may include secondary storage devices, like hard disks, floppy disks, and CD-ROM; or other forms of computer-readable memory. Such computer-readable media may be embodied by one or more components, including, for example, such as CPU 12, storage 18, database 20, or combinations of these and other components.

Furthermore, one skilled in the art will also realize that the processes illustrated in this description may be implemented in a variety of ways and include other modules, programs, applications, scripts, processes, threads, or code sections that may all functionally interrelate with each other to provide the functionality described above for each module, script, and daemon. For example, these programs modules may be implemented using commercially available software tools, using custom object-oriented code written in the C++ programming language, using applets written in the Java programming language, or may be implemented with discrete electrical components or as one or more hardwired application specific integrated circuits (ASIC) that are custom designed for this purpose.

The described implementation may include a particular network configuration but embodiments of the present disclosure may be implemented in a variety of data communication network environments using software, hardware, or a combination of hardware and software to provide the processing functions.

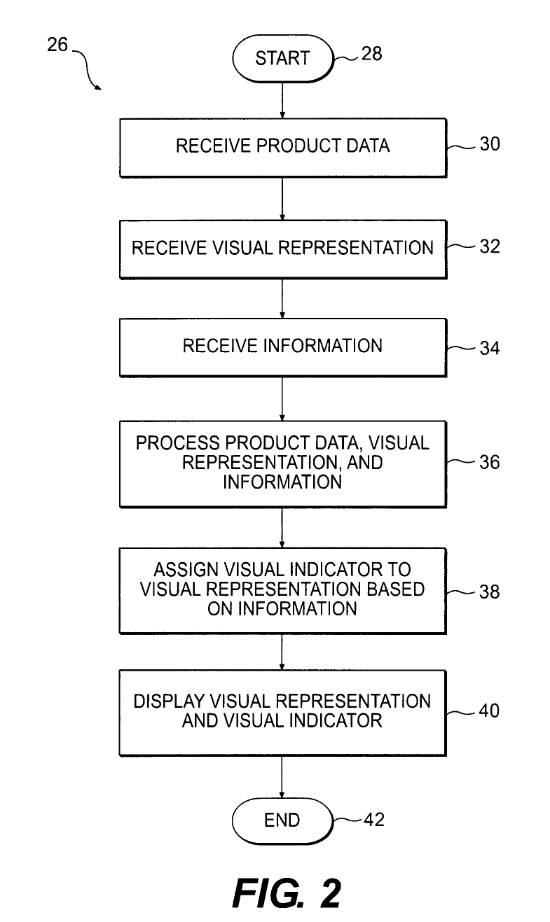

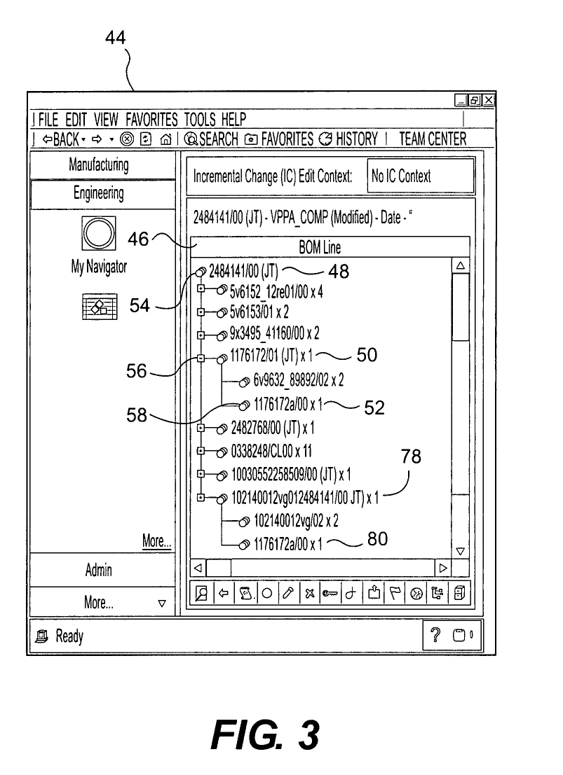

According to one aspect of this disclosure, system 10 may be used to perform a method 26, which will be described in reference to FIGS. 2-4. As shown in FIG. 2, method 26 may start (step 38) with CPU 12 receiving product data from database 20 or from an external source (step 30). The product data may include, for example, a BOM 46, as shown in display window 44 of FIG. 3. BOM 46 may include a listing of identifiers, including an product identifier 48 (2484141/00); an assembly identifier 50 (1176172/01); and a component identifier 52 (1176172a/00). Identifiers 48, 50, and 52 may be arranged with other identifiers in a hierarchy, the other identifiers including an assembly identifier 78 and a component identifier 80. The hierarchy may include a system in which a top level node 54 is provided that corresponds to an product, at least one intermediate level node 56 is provided that corresponds to an assembly that is part of the product, and at least one bottom level node 58 is provided that corresponds to a component that is a part of the assembly. Product identifier 48 may be assigned to top level node 54, assembly identifier 50 may be assigned to intermediate level node 56, and component identifier 52 may be assigned to bottom level node 58. It should be understood that the hierarchy may have any number of identifiers, nodes, and levels, depending on the characteristics of an product. The number of and types of nodes in BOM 46 have been provided for exemplary purposes, and are not intended to be limiting.

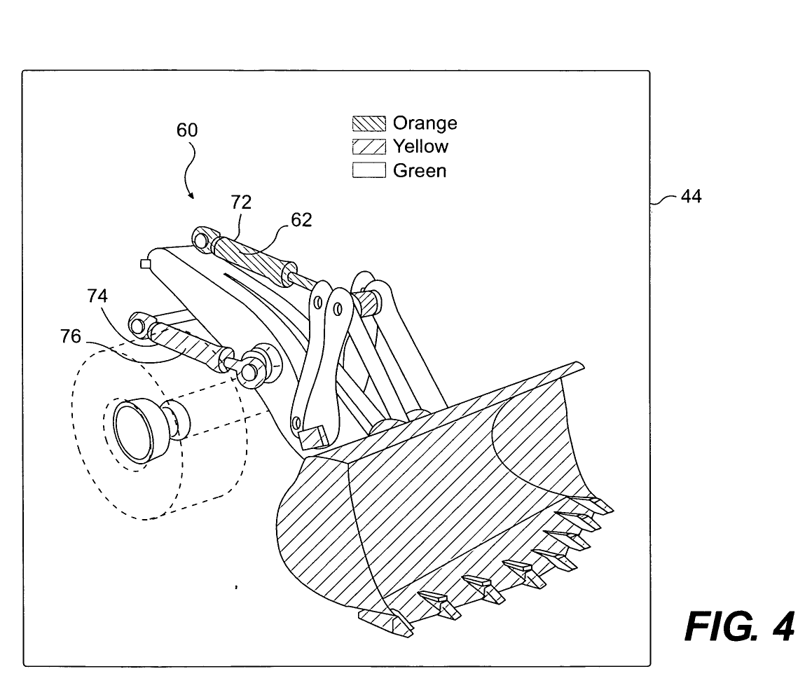

CPU 12 may also receive one or more visual representations, such as visual representation 60 of FIG. 4 (step 32). Visual representation 60 may include a 3-D model of an product, its assemblies, and its components. For example, visual representation 60 may include 3-D representations of parts 72 and 74. In exemplary visual representation 60, parts 72 and 74 may be identical parts, but may be used in different assemblies. Visual representation 60 may be included in display window 44. While the product represented by visual representation 60 may be a tool, as shown, it should be understood that the represented product may include an entire machine or a single component.

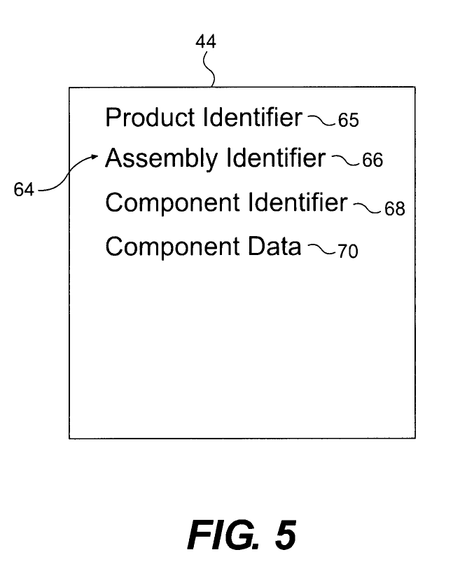

CPU 12 may also receive information, such as data sets, including, for example, a data set 64 shown in FIG. 5 (step 34). Data set 64 may be related to the product, assemblies, and components. Data set 64 may be displayed on or in display window 44. Data set 64 may include a product identifier 65, an assembly identifier 66, a component identifier 68, and component data 70.

Returning to the flow diagram of FIG. 2, system 10 may process BOM 46, visual representation 60, and data set 64 (step 36). Processing may include going through BOM 46, beginning with top level node 54, and moving down to lower level nodes. At each node, CPU 12 may identify the element of visual representation 60 corresponding to the node. That element may be shaded in with a neutral color so that it may be distinguishable from the background color of display window 44. Processing may also include determining whether data set 64 pertains to any of the products, assemblies, and components, represented by the nodes in BOM 46. For example, CPU 12 may compare product identifier 48 at top level node 54 with product identifier 65. If a match is not found, CPU 12 may move to the next product identifier (not shown). If a match is found, CPU 12 may compare the first assembly identifier down from top level node 54 to assembly identifier 66. If a match is not found, 64, CPU 12 may move on to the next assembly identifier. CPU 12 may continue in this manner until a match is found, for example, at intermediate level node 56. If CPU 12 finds a match between assembly identifier 50 at intermediate level node 56 and assembly identifier 66. CPU 12 may move down the branch extending from intermediate level node 56 to a first bottom level node, shown here as having the component identifier “6v9632_{—}89892/02.” CPU 12 may compare that component identifier to component identifier 68. If a match is not found, CPU 12 may move down to the next bottom level node, continuing in this manner until CPU 12 reaches component identifier 52 at bottom level node 58. If CPU 12 detects a match at bottom level node 58 between component identifiers 52 and 68, CPU 12 may link component data 70 to component identifier 52. Component identifier 52 may identify or correspond to part 72 in FIG. 4, and thus, component data 70 may be linked to part 72. This matching process may be repeated for each branch and node in BOM 46.

System 10 may then assign a visual indicator 62 to part 72 of visual representation 60 (step 38). Assigning visual indicator 62 may include filling part 72 with one or more colors and/or patterns. Assigning visual indicator 62 may also include bolding the outline of part 72, animating part 72, and/or using any other suitable methods for setting part 72 apart from other elements visually. The type, intensity, darkness, brightness, and/or shade of visual indicator 62 may be designed or selected to convey information to a user, such as, for example, one or more characteristics of component data 70. System 10 may display visual representation 60 of the product, along with visual indicator 62 (step 40). When all of the data sets that are of interest have been compared to the elements of BOM 46, and any matches have been made, method 26 may end (step 42).

If, for example, data set 64 matches with product, assembly, and component identifiers 48, 78, and 80, then, performing the steps described previously, CPU 12 may link component data 70 to component identifier 80. Component identifier 80 may identify or correspond to part 74 in FIG. 4, and thus, component data 70 may be linked to part 74.

System 10 may then assign a visual indicator 76 to part 74 of visual representation 60, where visual indicator 76 may be indicative of component data 70, rather than part 72. Thus, it should be apparent that visual indicators 62 and 76 applied to parts 72 and 74 may differ, although parts 72 and 74 may be identical and have identical component identifiers 52 and 80, respectively. The differentiation between identical parts comes as a result of the matching process. In order for component data 70 of data set 64 to be applied to a part, the product, of which the part is a component, must match product identifier 65. Then, the assembly, of which the part is a component, must match assembly identifier 66. If that occurs, then the part must match component identifier 68, and only then may component data 70 be linked to the part. If a match cannot be found at any point upstream (e.g., at the product level or the assembly level), CPU 12 may move to another branch of BOM 46. Thus, component data 70 for a first component may not be applied to a second component, identical to the first component, if the second component is part of a different product or assembly than the first component.

In exemplary embodiments, component data 70 may include a quantity or value indicative of the number of warranty claims made against an product, assembly, or component, with which component data 70 may be associated. Component data 70 may also be indicative of cost information, and may represent a monetary value. Component data 70 may also be indicative of source, and may represent a facility or supplier from which a product, assembly, or component, was received. It is also contemplated that component data 70 may be indicative of composition, and may represent a material type, process of making, or some other characteristic of a product, assembly, or component. Component data 70 may also be indicative of the total number purchased of a replacement part, the number of replacement parts ordered, or the frequency of use of a replacement part. Component data 70 may further be indicative of logistics planning, and may represent an aspect of logistics processes (e.g., receipt, storage, or delivery) that may be performed on a product, assembly, or component.

It is contemplated that the type of visual indicator used in visual representation 60 may be selected based on the type of component data being processed. For example, warranty claim information, cost information, source-identifying information, composition information, replacement parts information, and logistics planning information, may each be represented by a different color visual indicator in visual representation 60, and by using different shades of each color, values may be conveyed. This may allow visual representation 60 to convey a plurality of types of information simultaneously. Additionally or alternatively, different types of information may be conveyed using different categories of visual indicators. For example, one type of information may be represented using color, while other types may be represented using line patterns, bolding, or animation. Further, it is also contemplated that display window 44 may include a toolbar or menu allowing users to select the type of information that should be displayed on visual representation 60. If, for example, cost information is selected for display, visual representation 60 may show visual indicators indicative of cost only. If the user would like to see composition information, the user need only select that choice in the toolbar or menu, and visual representation 60 may show visual indicators indicative of composition only. Users may also be able to select more than one type of information for display at the same time, if desired.

Values may occupy positions along a color spectrum. Each element of visual representation 60 may be filled in with the color associated with its value. In the example shown in FIG. 4, the part 72 to which visual indicator 62 has been applied may represent the part having component identifier 52, which is a component of an assembly having assembly identifier 50, which in turn is a component of an product having product identifier 48. Visual indicator 62 may have been selected for application to the element because component data 70 is in a range of values corresponding to the color orange. Users may recognize visual indicator 62 as identifying problem parts. A threshold limit may be set, such that visual indicators may not be assigned to parts unless values assigned to those parts exceed the threshold limit.

While warranty claims, cost, source, composition, and logistics planning, have been described as a possible basis for assignment of visual indicators, it is also contemplated that other bases may be used. For example, in place of, or in addition to such information, any suitable information regarding products, assemblies, and components may form a basis for the assignment of visual indicator 62.

### INDUSTRIAL APPLICABILITY

A system 10 and method 26 for conveying information may have applicability in virtually any type of business, and in particular, those involving the sale of products. Products may include, for example, machines composed of one or more assemblies and components. Processes and methods consistent with the disclosed embodiments may provide a simple, easily understood graphical user interface for conveying information associated with products, assemblies, and components. As a result, users may be provided with the ability to identify and analyze problematic products, assemblies, and components, helping engineers, part designers, part producers, and technicians, among other interested parties, to design solutions to the problems.

Products, assemblies, and components may malfunction or experience other problems for any number of reasons. Causes may include overcost, supply issues, defects, harsh environmental conditions, operator abuse, and other factors. System 10 and method 26 may generate a display showing a visual representation 60, that allows users to distinguish problematic products, assemblies, and components, from others. Moreover, by generating a visual indicator 62, system 10 and method 26 may provide users with the ability to recognize the type of or magnitude of problems associated with products, assemblies, and components.

Further, visual representation 60 may provide a way for users to view assemblies and components in their contexts, that is, as they exist in an product. By visualizing assemblies and components in their respective contexts, a user may be able to identify whether problems in one assembly or component may be caused by or may be the cause of problems in another assembly or component. For example, if visual indicators in a localized area of visual representation 60 indicate that the group of components in that area suffer from frequent malfunctions, a user viewing visual representation 60 may be able to identify a potential cause of the malfunction by analyzing the surrounding assemblies and components. Also, identifying assemblies and components in their contexts may provide a user with the ability to distinguish between identical assemblies and components, which may be used in multiple parts of an product. Distinguishing between identical assemblies and components based on their contexts may be important, since their contexts may be an important factor in problem analysis. In some instances, the assemblies or components themselves may not have a defect that is the source of a problem, but rather, may experience problems when used in certain contexts. Using system 10 and method 26, a user may uncover such relationships, and may replace or redesign the assembly or component in that specific area, while maintaining the assembly or component in its present form in other areas of the product. This may reduce unnecessary repairs and replacements, and cut down on waste.

For example, a hydraulic cylinder may be used in several places in a machine. A dealer may find that customers may make a high number of warranty claims on the hydraulic cylinder due to the hydraulic cylinder malfunctioning. Instead of redesigning or replacing all of the hydraulic cylinders in the machine, a user may use system 10 and method 26 to determine how many warranty claims are made on each of the hydraulic cylinders. The number of warranty claims may be conveyed through the use of visual indicators on elements of visual representation 60. Viewing visual representation 60, the user may find that the majority of warranty claims are made on the hydraulic cylinder used in a single context, for example, on an arm of the machine. The user may focus his or her efforts on fixing, redesigning, or replacing only that hydraulic cylinder, while leaving the other hydraulic cylinders in their current form in the rest of the machine.

According to another feature of the present disclosure, a business may use system 10 and method 22 to distinguish between products, assemblies, and components based on cost. For example, visual indicators 62 may be indicative of the cost or overcost associated with the manufacture or purchase of the products, assemblies, or components. Using system 10, a spreadsheet or table of parts and their costs may be converted into visual representations and visual indicators to provide users, such as purchasing agents, with a way to visualize cost information. For example, the parts may be represented by visual representation 60, and visual indicators may be applied to the parts based on the cost or overcost of each of the parts. If parts or areas of high cost are identified, the purchasing agents may renegotiate terms with suppliers, or switch suppliers, in an effort to drive down costs.

According to yet another feature of the present disclosure, a business may use system 10 and method 26 to distinguish between products, assemblies, and components, based on their source. For example, different visual indicators may be assigned to products, assemblies, and components, of visual representation 60, indicative of the source from which they came. Visual indicators may also indicate whether products, assemblies, or components, came from an internal or external supplier.

According to yet another feature of the present disclosure, a business may use system 10 and method 26 to distinguish between products, assemblies, and components, based on composition. For example, visual indicators assigned to parts in visual representation 60 may be indicative of the material type, physical or chemical make up, or process used to prepare, products assemblies, and components.

According to yet another feature of the present disclosure, a business may use system 10 and method 26 to distinguish between products, assemblies, and components, by using replacement parts information. Replacement parts may be used to replace parts in products and assemblies when the parts have malfunctioned or otherwise failed. If a replacement part is in high demand, is frequently ordered, or has been installed frequently, that may indicate that the part being replaced by the replacement part is poorly designed, defective, or subject to stresses. In order to identify such problems, it may be helpful to apply visual indicators to visual representations of parts in a display to convey the frequency with which the parts have been replaced. While customers that purchase replacement parts may provide little or no information on how the purchased replacement parts are used, service technicians that install the replacement parts may keep records describing the context (e.g., product and assembly) in which each replacement part is used. The records, or replacement parts information, may include product identifiers, assembly identifiers, component identifiers, and frequency values. The replacement parts information may be entered into system 10, and system 10 may apply visual indicators based on the frequency or number of times each of the replacement parts has been used, using the methodology of method 26.

For example, a business may sell replacement hydraulic cylinders. The same replacement hydraulic cylinders may be used in many different products and assemblies. While knowledge of the total number of replacement hydraulic cylinders purchased or ordered may be helpful, it may also be beneficial to know how many of the purchased or ordered replacement hydraulic cylinders were used in specific contexts, that is, in particular products and assemblies, since the context may be a factor causing failures and malfunctions. Assuming that parts 72 and 74 are identical hydraulic cylinders, they may be replaced by the same replacement hydraulic cylinder. Based on the replacement parts information recorded by service technicians that install replacement hydraulic cylinders, it may be found that of the total number of replacement hydraulic cylinders sold, a large number of the replacement hydraulic cylinders were used in a first assembly of which part 72 is a component, while a small number of the replacement hydraulic cylinders were used in a second assembly, of which part 74 is a component. Visual indicators may be assigned to parts 72 and 74 by system 10 to indicate the number of replacement hydraulic cylinders used to replace parts 72 and 74, respectively. Thus, in this example, although parts 72 and 74 may be identical, and replaceable by identical replacement parts, they may have different visual indicators, since part 72 was replaced more often than part 74. By analyzing the visual indicators, business may recognize that the context in which part 72 is used may cause part 72 to fail or malfunction more frequently than part 74. Appropriate remedies may be designed to address such problems. It should be understood that while identical parts 72 and 74 are shown as being components of different assemblies in a single product, in other instances, identical parts may be used in different products. For example, the same hydraulic cylinder may be used in an excavator, loader, and dozer. System 10 may apply visual indicators to the parts using method 26, although the parts may be in entirely different products and/or assemblies.

According to yet another feature of the present disclosure, a business may use system 10 and method 26 to distinguish between products, assemblies, and components, based on logistics planning and processes used to procure, store, and deliver them. For example, visual indicators assigned to elements of visual representation 60 may be indicative of logistics performance measures. It should be understood that system 10 and method 26 may also use multiple visual indicators to convey warranty, cost, source, composition, and/or logistics planning information simultaneously or one at a time, depending on the needs of a user.

Using system 10 and method 26, users may gain an improved understanding of products, assemblies, and components. They may use the knowledge gleaned from system 10 and method 26 to resolve problems, increase the quality and life cycle of their products, schedule preventative maintenance, institute recalls, and perform any other suitable improvements to help avoid repair time and customer dissatisfaction.

It will be apparent to those skilled in the art that various modifications and variations can be made in the disclosed system and method without departing from the scope of the disclosure. Additionally, other embodiments of the disclosed system and method will be apparent to those skilled in the art from consideration of the specification. It is intended that the specification and examples be considered as exemplary only, with a true scope of the disclosure being indicated by the following claims and their equivalents.

What is claimed is:

1. A computer system comprising:
a platform;
a display device; and
a processor in communication with the platform and the display device, wherein the processor is configured to:
receive a bill of materials listing elements;
receive models of the elements;
receive information on characteristics of the elements;
identify matches between the information and the elements by comparing the information to each of the elements;
generate visual indicators on the models based on the matches; and
display the models and the visual indicators on the display device.

2. The computer system of claim 1, wherein the information includes at least one of warranty claim information, cost information, source-identifying information, composition information, and logistics planning information.

3. The computer system of claim 1, wherein the bill of materials includes two identical part numbers, wherein each of the identical part numbers is associated with different warranty claim information.

4. The computer system of claim 1, wherein the elements are listed in a hierarchy that includes a top level, one or more intermediate levels, and one or more bottom levels, and each of the elements is assigned to one of the top level, the one or more intermediate levels, and the one or more bottom levels.

5. The computer system of claim 4, wherein the processor is further configured to identify matches by comparing the information to the element assigned to the top level to identify matches between the information and the element assigned to the top level.

6. The computer system of claim 5, wherein if matches are identified between the information and the element assigned to the top level, the processor is further configured to compare the information to the elements assigned to the one or more intermediate levels to identify matches between the information and the elements assigned to the one or more intermediate levels.

7. The computer system of claim 6, wherein if matches are identified between the information and the elements assigned to the one or more intermediate levels, the processor is further configured to compare the information to the elements assigned to the one or more bottom levels to identify matches between the information and the elements assigned to the one or more bottom levels.

8. A computer readable medium, including instructions for:
receiving a bill of materials listing elements;
receiving models of the elements;
receiving information on characteristics of the elements;
identifying matches between the information and the elements by comparing the information to each of the elements;
generating visual indicators on the models based on the matches; and
displaying the models and the visual indicators on a display device.

9. The computer readable medium of claim 8, wherein receiving a bill of materials listing elements includes receiving two identical part numbers, wherein each of the identical part numbers is associated with different warranty claim information.

10. The computer readable medium of claim 8, wherein receiving a bill of materials listing elements includes receiving the elements in a hierarchy including a top level, one or more intermediate levels, and one or more bottom levels, with each of the elements being assigned to one of the top level, the one or more intermediate levels, and the one or more bottom levels.

11. The computer readable medium of claim 10, wherein the processor is further configured to identify matches by comparing the information to the element assigned to the top level to identify matches between the information and the element assigned to the top level.

12. The computer readable medium of claim 11, wherein if matches are identified between the information and the element assigned to the top level, identifying matches further includes comparing the information to the elements assigned to the one or more intermediate levels to identify matches between the information and the elements assigned to the one or more intermediate levels.

13. The computer readable medium of claim 12, wherein if matches are identified between the information and the elements assigned to the one or more intermediate levels, identifying matches further includes comparing the information to the elements assigned to the one or more bottom levels to identify matches between the information and the elements assigned to the one or more bottom levels.

14. A method for conveying warranty information, comprising:
receiving a bill of materials listing elements;
receiving models of the elements;
receiving information on characteristics of the elements;
identifying matches between the information and the elements by comparing the information to each of the elements;
generating visual indicators on the models based on the matches; and
displaying the models and the visual indicators on a display device.

15. The method of claim 14, wherein receiving the information includes receiving at least one of warranty claim information, cost information, source-identifying information, composition information, and logistics planning information, related to the elements.

16. The method of claim 15, wherein receiving a bill of materials listing elements includes receiving two identical part numbers, wherein each of the identical part numbers is associated with different warranty claim information.

17. The method of claim 14, wherein receiving a bill of materials listing elements includes receiving the elements in a hierarchy including a top level, one or more intermediate levels, and one or more bottom levels, with each of the elements being assigned to one of the top level, the one or more intermediate levels, and the one or more bottom levels.

18. The method of claim 17, wherein identifying matches includes comparing the information to the element assigned to the top level to identify matches between the information and the element assigned to the top level.

19. The method of claim 18, wherein if matches are identified between the information and the element assigned to the top level, identifying matches further includes comparing the information to the elements assigned to the one or more intermediate levels to identify matches between the information and the elements assigned to the one or more intermediate levels.

20. The method of claim 19, wherein if matches are identified between the information and the elements assigned to the one or more intermediate levels, identifying matches further includes comparing the information to the elements assigned to the one or more bottom levels to identify matches between the information and the elements assigned to the one or more bottom levels.
